(19) United States
(12) Patent Application Publication
(10) Pub. No.: US 2013/0039074 A1
(43) Pub. Date: Feb. 14, 2013

(54) Led Luminaire with Convection Cooling

(71) Applicant: Yi Ding, San Jose, CA (US)

(72) Inventor: Yi Ding, San Jose, CA (US)

(21) Appl. No.: 13/570,192

(22) Filed: Aug. 8, 2012

Related U.S. Application Data
(60) Provisional application No. 61/521,373, filed on Aug. 8, 2011.

(51) Int. Cl. F21V 29/02; F21V 5/04

(52) U.S. Cl. 362/311.01; 362/382

(57) ABSTRACT

A luminaire is provided for being configured to be installed at a fixed location. The luminaire includes an enclosure defining a cavity therein and having a surface. The luminaire may include a plurality of apertures disposed on the surface and configured to allow air to flow there through, wherein there exists a height differential between one aperture and another aperture. The luminaire may further include a semiconductor light source assembly for being received in the cavity, wherein light emitting surface of the semiconductor light source assembly is exposed to the air flowing through the enclosure, and wherein convective air flow takes place due to height differential between two apertures.

### RELATED U.S. APPLICATIONS

This application claims the priority of U.S. provisional application No. 61/521,373, filed Aug. 8, 2011. The application is incorporated herein by reference for all purposes.

### FIELD OF INVENTION

The invention disclosed herein generally relates to luminaires and, more specifically, to light emitting diode (LED) luminaires with convection cooling.

### BACKGROUND

Generally, a light emitting diode (LED) is believed to be future of lighting because of high efficiency and low environmental impact. LED luminaire is a device that utilizes LEDs as a source of illumination, in which current flowing in one direction through a junction region comprising two different semiconductors results in electrons and holes coupling at the junction region and generating a light beam. Further, the LEDs are resistant to shock and have an almost endless lifetime under specific conditions.

Owing to the aforementioned reasons and very little energy consumption during operation, LED luminaires have replaced conventional incandescent lamps in many products, such as decoration lamps, advertisement signs or traffic signs. The LEDs need to be mechanically secured and electrically connected inside a package that often contains a phosphor layer above the LED chip for color conversion and sometimes contains a lens above the phosphor layer.

### BRIEF DESCRIPTION OF FIGURES

The following detailed description of embodiments of the invention will be better understood when read in conjunction with the accompanying drawings. For the purpose of illustrating the invention, there is shown in the drawings, embodiments which are presently preferred. In the drawings, the left-most digit(s) of a reference number indicates the drawing in which the reference number first appears. The same reference numbers have been used throughout the drawings to indicate similar elements of the drawings.

FIG. 1 illustrates a bottom view of a luminaire, in accordance with an embodiment of the present invention;

FIG. 2 is a schematic illustration of a luminaire with convection air cooling, in accordance with an embodiment of the present invention;

FIG. 3 illustrates a flat surface luminaire, in accordance with another embodiment of the present invention;

FIG. 4 is a schematic illustration of convection air cooling in the flat surface luminaire, in accordance with another embodiment of the present invention.

FIG. 5 is a schematic illustration depicting attachment of a lens assembly to a luminaire, in accordance with an embodiment of the present invention.

### DETAILED DESCRIPTION

It will be readily understood that the components of the present invention, as generally described and illustrated in the figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Detailed embodiments of the invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the invention in virtually any appropriately detailed structure. Further, the terms and phrases used herein are not intended to be limiting, but rather to provide an understandable description of the invention.

Typically, light emitting diode (LED) modules are used in an LED lamp. Known implementations of LED modules in the LED lamp make use of a plurality of individual LEDs to generate light that is ample and of satisfactory spatial distribution. Further, the LEDs require very little energy consumption during operation. The LEDs are typically shipped without a printed circuit board (PCB) and therefore have to be mounted on PCBs. Presently, the LED lamps as replacement of fluorescent tubes predominantly comprise an array of LEDs mounted on a rectangular board placed inside a transparent tube or encapsulated by a transparent cover. These LED lamps, have LEDs encapsulated without adequate ventilation between the open space outside the luminaire and the encapsulated space surrounding the LEDs. Although the LED lamps can illuminate with very little power supply, the temperature will become higher when illumination and since there is no ventilation, heat dissipation from LEDs is ineffective, which reduces performance and lifetime of LEDs.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and/or mechanically.

In various embodiments of the specification, a luminaire is disclosed. The term “luminaire” used herein refers to a light fixture, light fitting, that may be used to create artificial light by use of an electric lamp. The luminaire may include one or more light sources of same or different types. The luminaire may include an enclosure defining a cavity therein. In one embodiment, a luminaire is provided for being configured to be installed at a fixed location and configured to allow convective airflow. This embodiment includes an enclosure defining a cavity therein and having at least one surface. The luminaire may include a plurality of apertures disposed on the surface and configured to allow air to flow there through, wherein there exists a height differential between one aperture and another aperture. The luminaire may further include a semiconductor light source assembly for being received in the cavity, wherein light emitting surface of the semiconductor light source assembly is exposed to the air flowing through the enclosure, and wherein convective air flow takes place due to height differential between two apertures.

In another embodiment, the enclosure may include more than one surface, such as a first surface and a second surface, such that the second surface is opposite to the first surface. Further, the first surface may be configured to be attached to a fixed location, such as a ceiling. The luminaire may further include a plurality of apertures disposed on the first surface and the second surface of the enclosure. In other words, a first set of apertures from the plurality of apertures may be configured on the first surface of the enclosure and a second set of apertures from the plurality of apertures may be configured on the second surface. Accordingly, there exists a height differential between the first set of apertures disposed on the first surface and the second set of apertures disposed on the second surface.

In addition, the luminaire may include a semiconductor light source assembly, such as a plurality of LEDs for being received in the cavity as defined by the enclosure. In an implementation, a light emitting surface of the semiconductor light source assembly is exposed to the air flowing through the enclosure. Further, due to the height differential between the first surface and the second surface, convective air flow takes place through the first set of apertures and the second set of apertures. The term LED may refer to an LED package, such as a white LED may typically include an LED package comprising blue-light-emitting LED chips and a phosphor layer to convert blue lights into longer wave length lights. Further, a “semiconductor light source assembly” refers to a lighting unit that includes one or more LED-based light sources as discussed above, alone or in combination with other non LED-based light sources.

The LED luminaire may be configured to create an efficient system for heat dissipation. The LED luminaire as disclosed in the invention is ventilated by the plurality of apertures, such that the cavity defined by the enclosure of the luminaire is not a closed system. This may facilitate in exchange of air, in a manner that the air heated up by LEDs exits the luminaire and cold air may enter the luminaire. In preferred embodiments, metal-core PCBs (MCPCB) may be used.

In one embodiment, a luminaire is provided that may be configured to be installed at a fixed location. The luminaire may include an enclosure defining a cavity therein. The enclosure may include a first surface and a second surface opposite to the first surface. The first surface may be configured to attach to the fixed location, such as a ceiling. The luminaire may further include a plurality of apertures disposed on the first surface and the second surface of the enclosure. The plurality of apertures may be configured to allow air to flow there through. In addition, there exists a height differential between a first set of apertures from the plurality of apertures disposed on the first surface and a second set of apertures disposed on the second surface. Furthermore, the luminaire may further include a semiconductor light source assembly for being received in the cavity. The light emitting surface of the semiconductor light source assembly may be exposed to the air flowing through the enclosure. Due to height differential between the plurality of apertures configured on the first surface and the second surface of the enclosure, the heat generated by the semiconductor light source assembly may be dissipated and air flow through convection takes place.

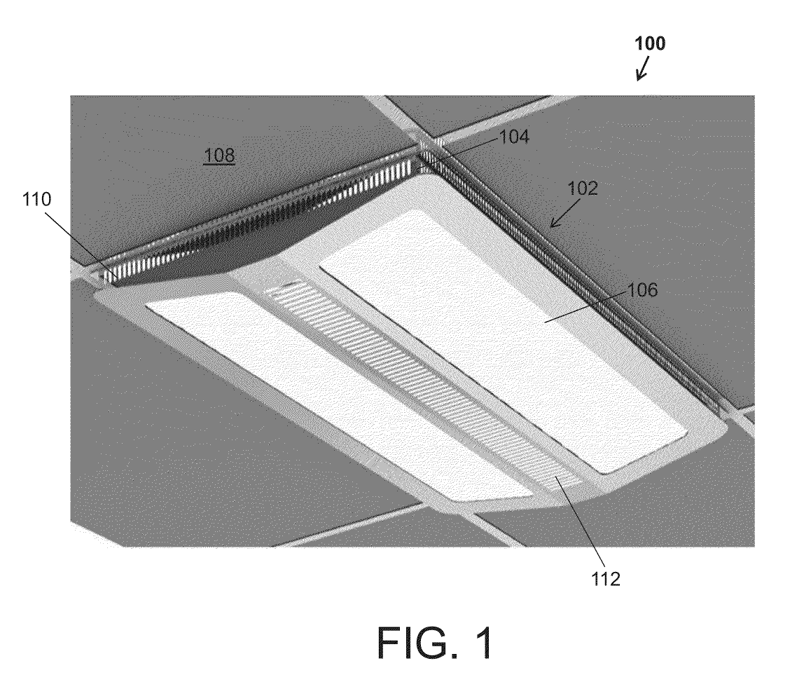

FIG. 1 illustrates a bottom view of a luminaire 100, in accordance with an embodiment of the present invention. The luminaire 100 may be understood as a light fixture that may be used to create artificial light by use of an electric lamp. The luminaire 100 may be configured to be installed at a fixed location. For example, the luminaire 100 may have any one of a variety of mounting arrangements for the light source(s), enclosure/housing arrangements and shapes, and/or electrical and mechanical connection configurations. Additionally, the luminaire 100 may optionally be associated with various other components, such as control circuitry, that may relate to the operation of the light source(s).

The luminaire 100 may include an enclosure 102 that may be configured to define a cavity (not shown) therein. The enclosure 102 may include a first surface 104 and a second surface 106 that may be configured opposite to the first surface 104. In an embodiment, the first surface 104 of the enclosure 102 may be configured to attach to a fixed location, such as a ceiling 108. The luminaire 100 may further include a plurality of apertures that may be disposed on the enclosure 102. Specifically, a first set of apertures 110 from the plurality of apertures may be disposed on the first surface 104 of the enclosure 102 and a second set of apertures 112 from the plurality of apertures may be disposed on the second surface 106 of the enclosure 102. The plurality of apertures may be configured to allow air to flow there through.

In a preferred embodiment, the luminaire 100 may be installed at a fixed location, such as a ceiling and a wall. Further, the luminaire may be oriented with respect to the ceiling, such that at heights, different sections of air flow paths are fixed, and the height differential along the paths determines the direction of convective air flow as hot air rises up, with certain apertures serving as air outlet and the other apertures as air inlet.

As may be evident from FIG. 1, there exists a height differential between the first set of apertures 110 disposed on the first surface 104 and the second set of apertures 112 disposed on the second surface 106. The luminaire 100 may further include a semiconductor light source assembly (not shown), such as LEDs for being received in the cavity defined by the enclosure 102. In an implementation, the luminaire 100 may include one or more light sources of same or different types. Further, a light emitting surface of the semiconductor light source assembly may be exposed to the air flowing through the enclosure 102. In addition, convective air flow takes place due to height differential between the first set of apertures 110 and the second set of apertures 112 configured on the first surface 104 and the second surface 106 of the enclosure 102.

As shown in FIG. 1, the second set of apertures 112 are configured in a middle region of the second surface 106 of the enclosure 102 of the luminaire 100. It will be evident to a person skilled in the art that the second set of apertures 112 may not be restricted to the middle region and may be configured at any place on the second surface 106. The second surface 106 is located below the ceiling 108 and therefore the second set of apertures 112 being on a lower height facilitate air inlet. On the other hand, the first set of apertures 110 are configured next to the ceiling 108 around outer edges of the enclosure 102 of the luminaire 100 and therefore are above the first set of apertures 110 configured for air outlet. In an embodiment, the second surface 106 of the enclosure 102 may be a lens assembly, such as slanted lenses and horizontal lenses. Further, the LEDs are mounted inside the cavity of the luminaire 100, and convective air flow passes the LEDs on their light-emitting side, thereby keeping the LED ambient temperature low.

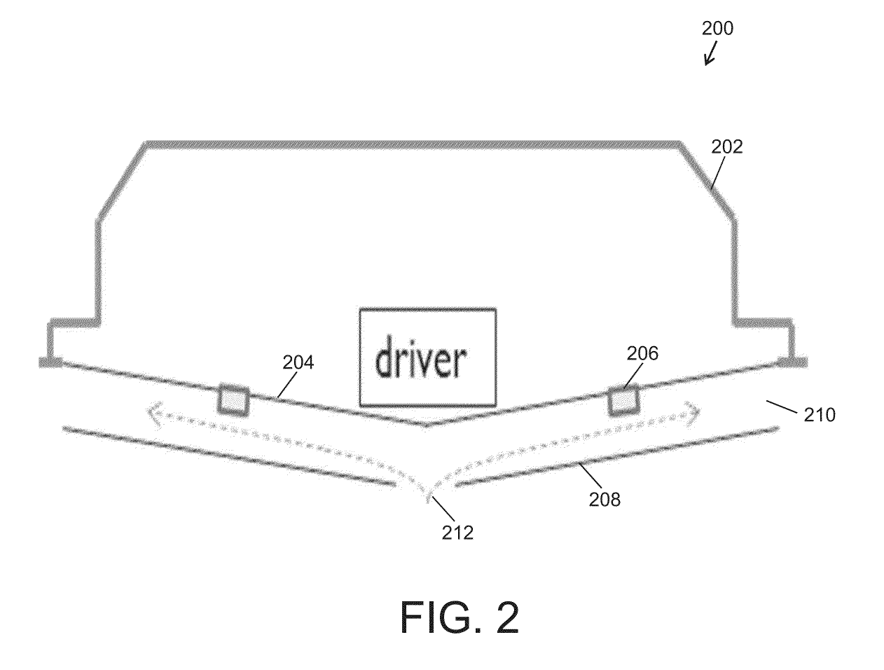

Referring to FIG. 2, a schematic illustration of a luminaire 200 with convection air cooling, in accordance with an embodiment of the present invention. The luminaire 200 is a lay-in fixture for T-bar ceiling grid 202. The luminaire 200 may form an enclosure with a first surface, such as an LED panel 204 to which a plurality of LEDs 206 may be coupled. In an embodiment, the first surface 204 may be a slanted surface. Further, the enclosure may include a second surface, such as a lens assembly 208. The lens assembly 208 is slanted in the present embodiment. The LED panel 204 may include the first set of apertures 210 and the lens assembly 208 may include the second set of apertures 212. As may be illustrated from FIG. 2, the lens assembly 208 may be removably mounted on the first surface 206 that may be seem from a room side. The second set of apertures 212 may act as air inlet and may allow air from outside to enter the enclosure. On the other hand, the first set of apertures 210 may act as air outlet.

In use, the air from the room may enter the luminaire 200 from the second set of apertures 212. As mentioned earlier, the light emitting surface of the LEDs is exposed to the air flow through the cavity defined by the enclosure. Accordingly, as the air comes in contact with the light emitting surface of the LEDs the heat of the LEDs may get transferred to the air. As a result, the air may become hot and the heated air may rise up in the cavity, due to pressure difference. Further, as there exists a height differential between the first surface 204 and the second surface 206, the hot air may escape to outside from the first set of apertures 210 located on the first surface 204 of the enclosure and giving rise to convective air flow. It will be evident to a person skilled in the art that slanted surfaces, such as the first surface 204 and the second surface 206 as illustrated in FIGS. 1 and 2 enhance convection.

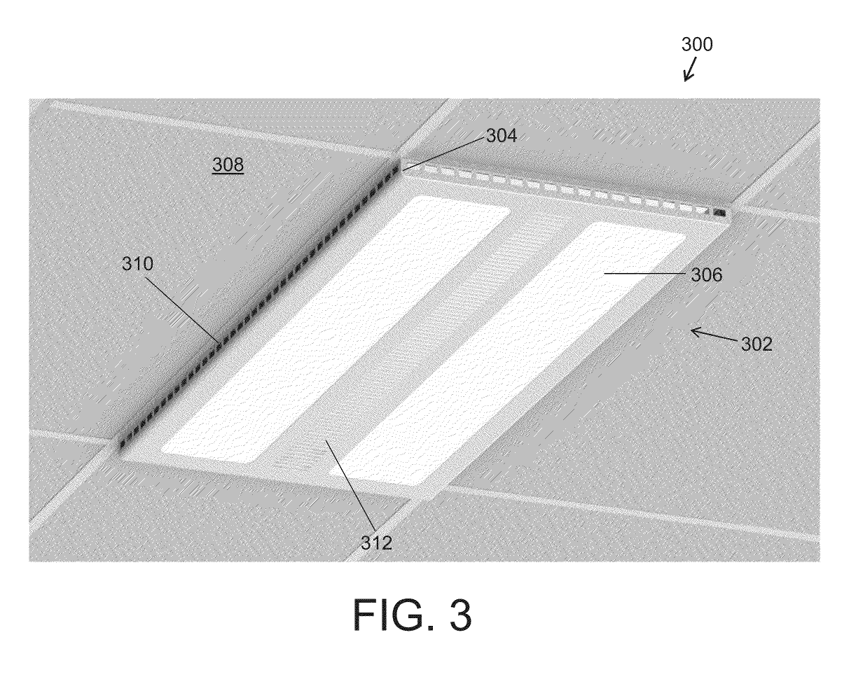

FIG. 3 illustrates a flat surface luminaire 300, in accordance with another embodiment of the present invention. As may be understood from FIG. 1, the flat surface luminaire 300 may include an enclosure 302 that may be configured to define a cavity (not shown) therein. The enclosure 302 may include a first surface 304 and a second surface 306 that may be configured opposite to the first surface 304. In an embodiment, the first surface 304 of the enclosure 302 may be configured to attach to a fixed location, such as a ceiling 308. The flat surface luminaire 300 may further include a plurality of apertures that may be disposed on the enclosure 302. Specifically, a first set of apertures 310 from the plurality of apertures may be disposed on the first surface 304 of the enclosure 302 and a second set of apertures 312 from the plurality of apertures may be disposed on the second surface 306 of the enclosure 302. The plurality of apertures may be configured to allow air to flow there through. As mentioned earlier, the first surface 304 may be an LED panel with horizontal surface. Further, the second surface 306 may be a lens assembly with horizontally mounted lenses. The horizontal first and second surfaces 304 and 306 may facilitate in convective air flow. Accordingly, the luminaire 300 provides a passive means of cooling the LEDs and dissipating the heat by means of apertures.

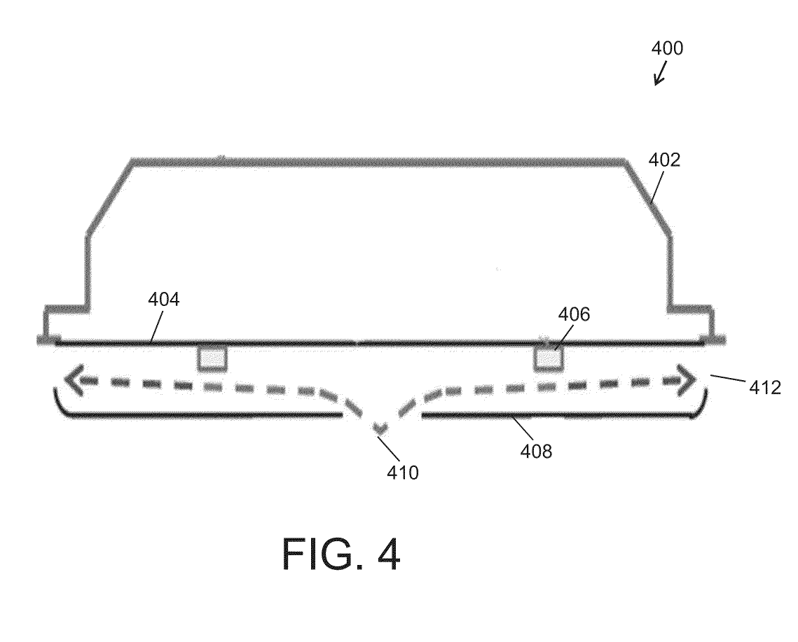

FIG. 4 is a schematic illustration of convection air cooling in the flat surface luminaire 400, in accordance with another embodiment of the present invention. The flat surface luminaire 400 may include an enclosure 402 having a first surface 404 having LEDs 406 attached thereto. The enclosure 402 may also include second surface 408. In an example, the first surface 404 is an LED panel and the second surface 408 is a lens assembly. Further, apertures are provided for maintaining a continuous exchange of air between outside air and inside air. For example, apertures 410 may allow air to enter the enclosure 402. As described earlier, the light emitting surface of the LEDs 406 is exposed to the flow of air, accordingly the air may get heated up and rise in the enclosure 402. Further, as a result of the height differential between the first surface 404 and the second surface 408, the hot may escape through the apertures 412.

It will be evident to a person skilled in the art that shape and orientation of the LED panel and the lens assembly may be different. For example, the first surface 402 and the second surface 408 may be curved. It will be understood that irrespective of the shape of the enclosure, a height differential may be required to exist between the inlet apertures, such as apertures 410 and outlet apertures, such as apertures 412. This may ensure that convective air exchange occurs between the cavity and the outside. It will also be evident that the apertures 410 for allowing the air to enter the enclosure 402 may are be located in other regions of the second surface 408, such as a side region.

In another embodiment, the luminaire, such as the luminaire 100 and the flat surface luminaire 300 may be used as a retrofit kit that may be mounted below a housing of a recessed fluorescent fixture. In yet another embodiment, the luminaires 100 and 300 as shown in FIGS. 1 and 3 may simply be adapted into lay-in fixtures on a T-bar ceiling grid or surface mounted fixtures by making necessary changes to the LED panel, while the lens assemblies may remain the same as those on the retrofit kits. A surface of the T-bar grid may be defined as the surface of the T-bar that is exposed toward the room and visible when installed. The luminaire may be mounted at or about the surface of the T-bar surface, and may alternatively be mounted at or below a tile installed in the T-bar grid, and may alternatively be mounted at any level about the ceiling.

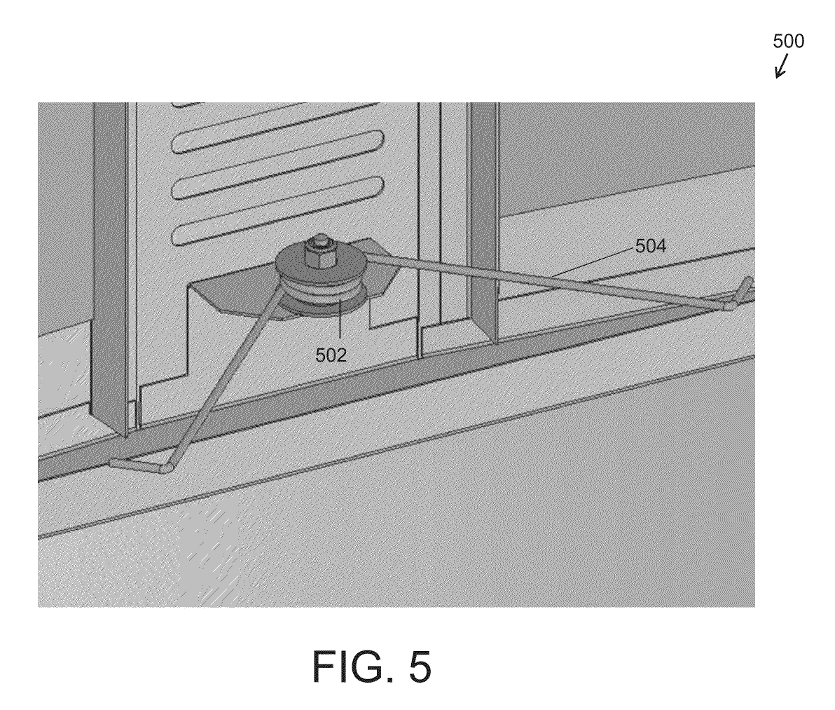

FIG. 5 is a schematic illustration depicting attachment of a lens assembly to a luminaire, in accordance with an embodiment of the present invention. In the present embodiment, the lens assembly may be attached to the luminaire, such as the luminaire as described with respect to FIGS. 1 to 4, by means of latches or torsion springs 502. In use, the torsion springs 502 may be squeezed so that the extending arms 504 may become nearly vertical. Thereafter, the arms 504 of each torsion spring 502 may be inserted into a slot on the LED panel that may be shorter than the relaxed span of the arms 504. When the lens assembly is pushed up, the torsion springs 502 are relaxed and the arms 504 sit against the ends of the said slots, thereby holding the lens assembly in contact with the LED panel.

It will be evident to a person skilled in the art that the invention may be embodied in other specific forms without departing from its spirit or essential characteristics. The described embodiments are to be considered in all respects only as illustrative and not restrictive. The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A luminaire configured to be installed at a fixed location, the luminaire comprising:
an enclosure defining a cavity therein, the enclosure having a first surface and a second surface opposite to the first surface, wherein the first surface is configured to attach to the fixed location;
a plurality of apertures disposed on the first surface and the second surface of the enclosure, the plurality of apertures configured to allow air to flow there through, wherein there exists a height differential between a first set of apertures from the plurality of apertures disposed on the first surface and a second set of apertures disposed on the second surface; and
a semiconductor light source assembly for being received in the cavity, wherein light emitting surface of the semiconductor light source assembly is exposed to the air flowing through the enclosure, and wherein convective air flow takes place due to height differential between the plurality of apertures configured on the first surface and the second surface of the enclosure.

2. The luminaire as claimed in claim 1, wherein the second surface of the enclosure is removably mounted on the first surface.

3. The luminaire as claimed in claim 1, wherein the second surface of the enclosure is a lens assembly.

4. The luminaire as claimed in claim 3, wherein the lens assembly comprises slanted lenses.

5. The luminaire as claimed in claim 1, wherein the second set of apertures disposed on the second surface acts as an air inlet for allowing outside air to enter the enclosure.

6. The luminaire as claimed in claim 1, wherein the first set of apertures disposed on the first surface acts as an air outlet for allowing hot air from the enclosure to escape.

7. The luminaire as claimed in claim 1, wherein the semiconductor light source assembly comprises a plurality of light emitting diodes (LEDs).

8. The luminaire as claimed in claim 1, wherein the luminaire is configured to be oriented with respect to the fixed location.

9. The luminaire as claimed in claim 1, wherein the second surface is oriented about the ceiling surface.

10. The luminaire as claimed in claim 10, wherein the ceiling surface is defined as the surface of a T-Bar ceiling grid.

11. The luminaire as claimed in claim 10, wherein the second surface is no higher than the ceiling.

12. A luminaire configured to be installed at a fixed location, the luminaire comprising:
an enclosure defining a cavity therein, the enclosure having a surface;
a plurality of apertures disposed on the surface and configured to allow air to flow there through, wherein there exists a height differential between one aperture and another aperture; and
a semiconductor light source assembly for being received in the cavity, wherein light emitting surface of the semiconductor light source assembly is exposed to the air flowing through the enclosure, and wherein convective air flow takes place due to height differential between two apertures.
